(19) United States
(12) Patent Application Publication
(10) Pub. No.: US 2025/0384187 A1
(43) Pub. Date: Dec. 18, 2025

(54) HIGH-RESOLUTION ELECTRICITY LOAD FORECASTING

(71) Applicant: Utilidata, Inc., Providence, RI (US)

(72) Inventors: Kevin Smith, Aliso Viejo, CA (US); Daria Pankova, State College, PA (US); Ashley King, East Greenwich, RI (US)

(73) Assignee: Utilidata, Inc., Providence, RI (US)

(21) Appl. No.: 19/042,611

(22) Filed: Jan. 31, 2025

Related U.S. Application Data
(60) Provisional application No. 63/659,693, filed on Jun. 13, 2024.

(51) Int. Cl. G06F 30/27; G06F 113/04; H02J 3/00

(52) U.S. Cl. CPC G06F 30/27; H02J 3/003; G06F 2113/04

(57) ABSTRACT

High-resolution electricity load forecasting is provided. A data processing system, located at a site, can obtain a waveform data set comprising characteristics of power consumption measured for the site during a first time interval at a first sampling rate; determine power-system values based on the waveform data set; determine harmonic information based on a frequency transform performed on the waveform data set; construct, based on the power-system values and the harmonic information (as well as other exogeneous inputs such as weather), a processed waveform data set having a time series of values at a second sampling rate; predict, based on the processed waveform data set, using one or more models, a characteristic of load at the site during a second time interval; and execute an action related to power delivery for the site based on the characteristic of the load predicted during the second time interval.

### CROSS-REFERENCES TO RELATED APPLICATIONS

This application claims the benefit of priority under 35 U.S.C. § 119 to U.S. Provisional Patent Application No. 63/659,693, filed Jun. 13, 2024, which is hereby incorporated by reference herein in its entirety.

### FIELD OF THE DISCLOSURE

This disclosure relates generally to systems and methods of distributing electricity over a utility grid, including, for example, forecasting or predicting load on the electric distribution grid.

### BACKGROUND

Utility distribution grids can generate and distribute electric power to various customer sites. The utility distribution grids can supply power via transmission or distribution lines to various loads at the customer sites, such as consumer electric devices or residential charging infrastructures.

### BRIEF SUMMARY OF THE DISCLOSURE

Utility distribution grids can use meters to observe or measure the delivery or consumption (e.g., electricity or power) by an end load (or customer) in the grid. These meters, among other components within utility distribution grids, can collect samples of power delivery or consumption, such as voltage information, at a sample rate (e.g., one sample every 15 to 60 minutes). The collected data samples can be used to manage electricity generation for distribution to devices at the grid edge (e.g., edge devices, such as for residential areas or entities) or manage load at the grid edge for load balancing, demand response, peak load management, etc. An edge device can refer to or include a hardware device (e.g., a computing device with one or more processors and memory) that can process data locally at the edge of a distribution grid (e.g., at or near an end load, customer, or metering device), as opposed to having to send the data to a centralized data center that is remote from the end load or customer. However, as the mix of electricity at the grid edge becomes more complex and flexible (e.g., with the inclusion of solar panels, electric vehicles (EVs), battery storage systems, or other power (or electricity) storage or generation systems), visibility into the relatively short-term forecast may be limited due to relatively low-resolution data of certain systems.

Aspects of the technical solutions disclosed herein provide an accurate, high-resolution-in-time load forecasting to allow or facilitate effective local control of the loads at the grid edge due to varying conditions that may affect the electrical generation or storage, e.g., cloud movement or certain weather conditions can cause fluctuation in the solar panel output or the presence or absence of the EV can affect the electrical consumption or supply, depending on the configuration of the EV. The technical solutions can include or use a data processing system (e.g., metering device) to process data locally, e.g., around residential areas or local sites. The data processing system can process the data to obtain a short-term, granular forecast at a relatively higher sampling rate and with relatively higher accuracy compared to a long-term forecast. Based on the short-term forecast, the utility grid can take one or more actions to account for electricity generation and load. These actions can include, for example, one or more of adjusting a capacitor setting, installing or adjusting a voltage regulator or transformer, adjusting a tap setting on the voltage transformer, installing or adjusting switches, installing or activating distributed energy resource (DER) dispatch, or scheduling additional electricity generation during a time period in which there is a forecasted power spike. The technical solutions of this disclosure can execute these or other actions configured to manage the generation and consumption of electricity or power.

An aspect of this technical solution is directed to a system for high-resolution electricity load forecasting. The system can include a data processing system, which can include one or more processors coupled with memory. The data processing system can be located at a site. The data processing system can obtain a waveform data set comprising characteristics of power consumption measured for the site during a first time interval at a first sampling rate. The data processing system can determine power-system values based on the waveform data set. The data processing system can determine harmonic information based on a frequency transform performed on the waveform data set. The data processing system can construct, based on the power-system values and the harmonic information, a processed waveform data set having a time series of values at a second sampling rate, wherein the second sampling rate is less than the first sampling rate. The data processing system can predict, based on the processed waveform data set, using one or more models, a characteristic of load at the site during a second time interval. The data processing system can execute an action related to power delivery for the site based on the characteristic of the load predicted during the second time interval.

In some cases, the characteristics of power consumption can include voltage waveforms and current waveforms. In some cases, the first sampling rate can be at least 7 kHz. The first sampling rate can be at least 32 kHz. The harmonic information can include magnitude and phase information. The power-system values can comprise at least one of reactive power, real power, or apparent power.

The data processing system can generate statistical metrics based on the harmonic information. The data processing system can detect, based on the statistical metrics, anomalies in the waveform data set. The data processing system can remove the anomalies from the waveform data set. The data processing system can construct the processed waveform data set with the anomalies removed.

To predict the characteristic of the load at the site during the second time interval, the data processing system can detect, using the one or more models, patterns in the processed waveform data set. The data processing system can input the patterns into the one or more models to predict the characteristic of the load at the site during the second time interval. The one or more models can comprise a convolution neural network. The data processing system can detect the patterns using the convolution neural network.

The one or more models can include a recurrent neural network architecture. The data processing system can input the patterns into the recurrent neural network architecture to predict the characteristic of the load at the site during the second time interval. The one or more models can comprise a linear regression technique. The data processing system can predict, using the linear regression technique, the characteristic of the load at the site during the second time interval. The one or more models can comprise a decision tree architecture. The data processing system can predict, using the decision tree architecture, the characteristic of the load at the site during the second time interval.

The data processing system can obtain a second waveform data set comprising the characteristics of power consumption measured for the site during the second time interval at the first sampling rate. The data processing system can determine a characteristic of the load based on the second waveform data set. The data processing system can compare the characteristic of the load based on the second waveform data set with the characteristic of the load predicted during the second time interval. The data processing system can update the one or more models based on the comparison.

The data processing system can compare the characteristic of the load predicted during the second time interval with a threshold. The data processing system can execute, based on the comparison, the action comprising transmitting a notification of the comparison to a server remote from the data processing system.

An aspect of this technical solution is directed to a method for high-resolution electricity load forecasting. The method can include obtaining, by a data processing system, comprising one or more processors coupled with memory, located at a site, a waveform data set comprising characteristics of power consumption measured for the site during a first time interval at a first sampling rate. The method can include determining, by the data processing system, power-system values based on the waveform data set. The method can include determining, by the data processing system, harmonic information based on a frequency transform performed on the waveform data set. The method can include construct, by the data processing system, based on the power-system values and the harmonic information, a processed waveform data set having a time series of values at a second sampling rate, wherein the second sampling rate is less than the first sampling rate. The method can include predicting, by the data processing system, based on the processed waveform data set, using one or more models, a characteristic of load at the site during a second time interval. The method can include executing, by the data processing system, an action related to power delivery for the site based on the characteristic of the load predicted during the second time interval.

The method can include generating, by the data processing system, statistical metrics based on the harmonic information. The method can include detecting, by the data processing system, based on the statistical metrics, anomalies in the waveform data set. The method can include removing, by the data processing system, the anomalies from the waveform data set. The method can include constructing, by the data processing system, the processed waveform data set with the anomalies removed.

To predict the characteristic of the load at the site during the second time interval, the method can include detecting, by the data processing system, using the one or more models, patterns in the processed waveform data set. The method can include inputting, by the data processing system, the patterns into the one or more models to predict the characteristic of the load at the site during the second time interval.

The method can include comparing, by the data processing system, the characteristic of the load predicted during the second time interval with a threshold. The method can include executing, by the data processing system, based on the comparison, the action comprising transmitting a notification to a server remote from the data processing system. The characteristics of power consumption can comprise voltage waveforms and current waveforms. The first sampling rate can be at least 32 kHz. The harmonic information can comprise magnitude and phase information.

An aspect of this technical solution is directed to a non-transitory computer readable storage medium for high-resolution electricity load forecasting. The non-transitory computer-readable medium storing processor executable instructions that, when executed by one or more processors, cause the one or more processors to: obtain a waveform data set comprising characteristics of power consumption measured for a site during a first time interval at a first sampling rate; determine power-system values based on the waveform data set; determine harmonic information based on a frequency transform performed on the waveform data set; construct, based on the power-system values and the harmonic information, a processed waveform data set having a time series of values at a second sampling rate, wherein the second sampling rate is less than the first sampling rate; predict, based on the processed waveform data set, using one or more models, a characteristic of load at the site during a second time interval; and execute an action related to power delivery for the site based on the characteristic of the load predicted during the second time interval.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE FIGURES

The accompanying drawings are not intended to be drawn to scale. Like reference numbers and designations in the various drawings indicate like elements having similar structure or functionality. For purposes of clarity, not every component may be labeled in every drawing. In the drawings:

FIG. 1 is a block diagram depicting an illustrative utility grid, in accordance with an implementation;

FIG. 2 is a block diagram illustrating an example system to forecast electrical load, in accordance with an implementation;

FIG. 3 is a flow diagram of an example method for high-resolution electricity load forecasting, in accordance with an implementation; and

FIG. 4 is a block diagram illustrating an architecture for a computer system that can be employed to implement elements of the systems and methods described and illustrated herein, including, for example, aspects of the utility grid depicted in FIG. 1, the system depicted in FIG. 2, and the operations depicted in FIG. 3.

The features and advantages of the present solution will become more apparent from the detailed description set forth below when taken in conjunction with the drawings, in which like reference characters identify corresponding elements throughout. Other features, aspects, and advantages of the subject matter will become apparent from the description, the drawings, and the claims.

### DETAILED DESCRIPTION

Following below are more detailed descriptions of various concepts related to, and implementations of, methods, apparatuses, and systems of high-resolution information-rich load forecasting. The various concepts introduced above and discussed in greater detail below may be implemented in any of numerous ways.

In utility distribution grids, meters or other components within utility distribution grids can collect samples of power delivery or consumption for processing. The collected data samples can be used to manage electricity generation upstream of the electricity consumers for distribution to edge devices or manage load distributed at the grid edge. However, because of the complexity and flexibility of mixing electricity at the grid edge (e.g., by the input or output of the solar panels, EVs, battery storage systems, or other power storage or generation systems), forecasting using low-resolution data may be inaccurate and there may be limited visibility into the short-term forecast.

Hence, the systems and methods of the technical solution discussed herein can provide accurate, high-resolution-in-time load forecasting to allow or enable effective local control of the loads at the grid edge due to varying conditions that may affect the electrical generation or storage. The systems and methods can account for various conditions that may affect electrical generation or supply, e.g., time of day, cloud movement or certain weather conditions which may cause fluctuation in the solar panel output, or time periods the EV is at the residential area, for example. The systems and methods can include a data processing system (e.g., metering device) to process data locally, e.g., around residential areas or local sites. The systems and methods can process the data to obtain a short-term, granular forecast at a relatively higher sampling rate and with relatively higher accuracy compared to a long-term forecast. Based on the short-term forecasting, the utility grid can take one or more actions to account for electricity generation and load, such as adjusting the capacitor setting, installation of voltage regulators or transformers, or adjusting tap settings on voltage transformers for voltage stability, installation of switches, DER dispatch, scheduling electrical generation during forecasted power spike time period, for example. The systems and methods can take other actions for managing electrical generation and consumption, not limited to those discussed herein.

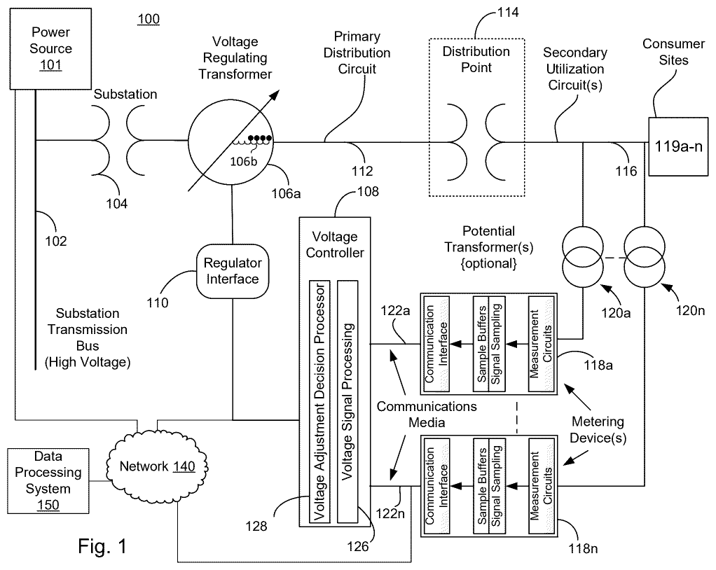

FIG. 1 is an example utility distribution environment. The utility distribution environment can include a utility grid 100. The utility grid 100 can include an electricity distribution grid with one or more devices, assets, or digital computational devices and systems, such as a data processing system 150. In brief overview, the utility grid 100 includes a power source 101 that can be connected via a subsystem transmission bus 102, or via substation transformer 104, to a voltage regulating transformer 106a. The voltage regulating transformer 106a can be controlled by voltage controller 108 with regulator interface 110. Voltage regulating transformer 106a can be optionally coupled on primary distribution circuit 112 via optional distribution transformer 114 to secondary utilization circuits 116 and to one or more electrical or electronic devices 119. Voltage regulating transformer 106a can include multiple tap outputs 106b with each tap output 106b supplying electricity with a different voltage level. The utility grid 100 can include monitoring devices 118a-118n that can be coupled through optional potential transformers 120a-120n to secondary utilization circuits 116. The monitoring or metering devices 118a-118n can detect (e.g., continuously, periodically, based on a time interval, responsive to an event or trigger) measurements and continuous voltage signals of electricity supplied to one or more electrical devices 119 connected to circuit 112 or 116 from a power source 101 coupled to bus 102. A voltage controller 108 can receive, via a communication media 122, measurements obtained by the metering devices 118a-118n, and use the measurements to make a determination regarding a voltage tap settings, and provide an indication to regulator interface 110. The regulator interface can communicate with voltage regulating transformer 106a to adjust an output tap level 106b.

The utility grid 100 can include, access, or otherwise electrically couple with a power source 101. The power source 101 can include a power plant such as an installation configured to generate electrical power for distribution. The power source 101 can include an engine or other apparatus that generates electrical power. The power source 101 can create electrical power by converting power or energy from one state to another state. In some embodiments, the power source 101 can be referred to or include a power plant, power station, generating station, powerhouse or generating plant. In some embodiments, the power source 101 can include a generator, such as a rotating machine that converts mechanical power into electrical power by creating relative motion between a magnetic field and a conductor. The power source 101 can use one or more energy source to turn the generator including, e.g., fossil fuels such as coal, oil, and natural gas, nuclear power, or cleaner renewable sources such as solar, wind, wave and hydroelectric.

In some embodiments, the utility grid 100 includes one or more substation transmission bus 102. The substation transmission bus 102 can include or refer to transmission tower, such as a structure (e.g., a steel lattice tower, concrete, or wood), that supports an overhead power line used to distribute electricity from a power source 101 to a substation 104 or distribution point 114. Transmission towers 102 can be used in high-voltage alternating current (AC) and direct current (DC) systems, and come in a wide variety of shapes and sizes. In an illustrative example, a transmission tower can range in height from 15 to 55 meters or more. Transmission towers 102 can be of various types including, e.g., suspension, terminal, tension, and transposition. In some embodiments, the utility grid 100 can include underground power lines in addition to or instead of transmission towers 102.

In some embodiments, the utility grid 100 includes a substation 104 or electrical substation 104 or substation transformer 104. A substation can be part of an electrical generation, transmission, and distribution system. In some embodiments, the substation 104 transform voltage from high to low, or the reverse, or performs any of several other functions to facilitate the distribution of electricity. In some embodiments, the utility grid 100 can include several substations 104 between the power source 101 and the consumer electoral devices 119 with electric power flowing through them at different voltage levels.

The substations 104 can be remotely operated, supervised and controlled (e.g., via a supervisory control and data acquisition system or data processing system 150). A substation can include one or more transformers to change voltage levels between high transmission voltages and lower distribution voltages, or at the interconnection of two different transmission voltages.

The regulating transformer 106 can include: (1) a multi-tap autotransformer (single or three phase), which are used for distribution; or (2) on-load tap changer (three phase transformer), which can be integrated into a substation transformer 104 and used for both transmission and distribution. The illustrated system described herein can be implemented as either a single-phase or three-phase distribution system. The utility grid 100 can include an AC power distribution system and the term voltage can refer to a root mean square (RMS) voltage, in some embodiments.

The utility grid 100 can include a distribution point 114 or distribution transformer 114, which can refer to an electric power distribution system. In some embodiments, the distribution point 114 can be a final or near final stage in the delivery of electric power. For example, the distribution point 114 can carry electricity from the transmission system (which can include one or more transmission towers 102) to individual consumers 119. In some embodiments, the distribution system can include the substations 104 and connect to the transmission system to lower the transmission voltage to medium voltage ranging between 2 kV and 35 kV with the use of transformers, for example. Primary distribution lines or circuit 112 carry this medium voltage power to distribution transformers located near the customer's premises 119. Distribution transformers can further lower the voltage to the utilization voltage of appliances and can feed several customers 119 through secondary distribution lines or circuits 116 at this voltage. Commercial and residential customers 119 can be connected to the secondary distribution lines through service drops. In some embodiments, customers demanding high load can be connected directly at the primary distribution level or the sub-transmission level.

The utility grid 100 can include or couple to one or more consumer sites 119. Consumer sites 119 can include, for example, a building, house, shopping mall, factory, office building, residential building, commercial building, stadium, movie theater, etc. The consumer sites 119 can be configured to receive electricity from the distribution point 114 via a power line (above ground or underground). A consumer site 119 can be coupled to the distribution point 114 via a power line. The consumer site 119 can be further coupled to a site meter 118a-n or advanced metering infrastructure (AMI). The site meter 118a-n can be associated with a controllable primary circuit segment 112. The association can be stored as a pointer, link, field, data record, or other indicator in a data file in a database.

The utility grid 100 can include site meters 118a-n or AMI. Site meters 118a-n can measure, collect, and analyze energy usage, and communicate with metering devices such as electricity meters, gas meters, heat meters, and water meters, either on request or on a schedule. Site meters 118a-n can include hardware, software, communications, consumer energy displays and controllers, customer associated systems, Meter Data Management (MDM) software, or supplier business systems. In some embodiments, the site meters 118a-n can obtain samples of electricity usage in real time or based on a time interval, and convey, transmit or otherwise provide the information. In some embodiments, the information collected by the site meter can be referred to as meter observations or metering observations and can include the samples of electricity usage. In some embodiments, the site meter 118a-n can convey the metering observations along with additional information such as a unique identifier of the site meter 118a-n, unique identifier of the consumer, a time stamp, date stamp, temperature reading, humidity reading, ambient temperature reading, etc. In some embodiments, each consumer site 119 (or electronic device) can include or be coupled to a corresponding site meter or monitoring device 118a-118n.

Monitoring devices 118a-118n can be coupled through communications media 122a-122n to voltage controller 108. Voltage controller 108 can compute (e.g., discrete-time, continuously or based on a time interval or responsive to a condition or event) values for electricity that facilitates regulating or controlling electricity supplied or provided via the utility grid. For example, the voltage controller 108 can compute estimated deviant voltage levels that the supplied electricity (e.g., supplied from power source 101) will not drop below or exceed as a result of varying electrical consumption by the one or more electrical devices 119. The deviant voltage levels can be computed based on a predetermined confidence level and the detected measurements. Voltage controller 108 can include a voltage signal processing circuit 126 that receives sampled signals from metering devices 118a-118n. Metering devices 118a-118n can process and sample the voltage signals such that the sampled voltage signals are sampled as a time series (e.g., uniform time series free of spectral aliases or non-uniform time series).

Voltage signal processing circuit 126 can receive signals via communications media 122a-n from metering devices 118a-n, process the signals, and feed them to voltage adjustment decision processor circuit 128. Although the term “circuit” is used in this description, the term is not meant to limit this disclosure to a particular type of hardware or design, and other terms known generally known such as the term “element”, “hardware”, “device” or “apparatus” could be used synonymously with or in place of term “circuit” and can perform the same function. For example, in some embodiments the functionality can be carried out using one or more digital processors, e.g., implementing one or more digital signal processing algorithms. Adjustment decision processor circuit 128 can determine a voltage location with respect to a defined decision boundary and set the tap position and settings in response to the determined location. For example, the adjustment decision processing circuit 128 in voltage controller 108 can compute a deviant voltage level that is used to adjust the voltage level output of electricity supplied to the electrical device. Thus, one of the multiple tap settings of regulating transformer 106 can be continuously selected by voltage controller 108 via regulator interface 110 to supply electricity to the one or more electrical devices based on the computed deviant voltage level. The voltage controller 108 can also receive information about voltage regulator transformer 106a or output tap settings 106b via the regulator interface 110. Regulator interface 110 can include a processor-controlled circuit for selecting one of the multiple tap settings in voltage regulating transformer 106 in response to an indication signal from voltage controller 108. As the computed deviant voltage level changes, other tap settings 106b (or settings) of regulating transformer 106a are selected by voltage controller 108 to change the voltage level of the electricity supplied to the one or more electrical devices 119.

The network 140 can be connected via wired or wireless links. Wired links can include Digital Subscriber Line (DSL), coaxial cable lines, or optical fiber lines. The wireless links can include BLUETOOTH, Wi-Fi, Worldwide Interoperability for Microwave Access (WiMAX), an infrared channel or satellite band. The wireless links can also include any cellular network standards used to communicate among mobile devices, including standards that qualify as 1G, 2G, 3G, or 4G. The network standards can qualify as one or more generation of mobile telecommunication standards by fulfilling a specification or standards such as the specifications maintained by International Telecommunication Union. The 3G standards, for example, can correspond to the International Mobile Telecommunications-2000 (IMT-2000) specification, and the 4G standards can correspond to the International Mobile Telecommunications Advanced (IMT-Advanced) specification. Examples of cellular network standards include Advanced Mobile Phone System (AMPS), Global System for Mobile Communication (GSM), General Packet Radio Service (GPRS), Universal Mobile Telecommunications Service (UMTS), Long Term Evolution (LTE), LTE Advanced, Mobile WiMAX, and WiMAX-Advanced. Cellular network standards can use various channel access methods e.g. Frequency Division Multiple Access (FDMA), Time Division Multiple Access (TDMA), Code Division Multiple Access (CDMA), or Space Division Multiple Access (SDMA). In some embodiments, different types of data can be transmitted via different links and standards. In other embodiments, the same types of data can be transmitted via different links and standards.

The network 140 can be any type or form of network. The geographical scope of the network 140 can vary widely and the network 140 can be a body area network (BAN), a personal area network (PAN), a local-area network (LAN), e.g. Intranet, a metropolitan area network (MAN), a wide area network (WAN), or the Internet. The topology of the network 140 can be of any form and can include, e.g., any of the following: point-to-point, bus, star, ring, mesh, or tree. The network 140 can be an overlay network which is virtual and sits on top of one or more layers of other networks 140. The network 140 can be of any such network topology as known to those ordinarily skilled in the art capable of supporting the operations described herein. The network 140 can utilize different techniques and layers or stacks of protocols, including, e.g., the Ethernet protocol, the Internet Protocol Suite (TCP/IP), the Asynchronous Transfer Mode (ATM) technique, the Synchronous Optical Networking (SONET) protocol, or the Synchronous Digital Hierarchy (SDH) protocol. The TCP/IP internet protocol suite can include application layer, transport layer, internet layer (including, e.g., IPv6), or the link layer. The network 140 can be a type of a broadcast network, a telecommunications network, a data communication network, or a computer network.

The network 140 can include computer networks such as the internet, local, wide, near field communication, metro or other area networks, as well as satellite networks or other computer networks such as voice or data mobile phone communications networks, and combinations thereof. The network 140 can include a point-to-point network, broadcast network, telecommunications network, asynchronous transfer mode network, synchronous optical network, or a synchronous digital hierarchy network, for example. The network 140 can include at least one wireless link such as an infrared channel or satellite band. The topology of the network 140 can include a bus, star, or ring network topology. The network 140 can include mobile telephone or data networks using any protocol or protocols to communicate among vehicles or other devices, including advanced mobile protocols, time or code division multiple access protocols, global system for mobile communication protocols, general packet radio services protocols, or universal mobile telecommunication system protocols, and the same types of data can be transmitted via different protocols.

One or more components, assets, or devices of utility grid 100 can communicate via network 140. The utility grid 100 can use one or more networks, such as public or private networks. The utility grid 100 can communicate or interface with a data processing system 150 designed and constructed to communicate, interface or control the utility grid 100 via network 140. Each asset, device, or component of utility grid 100 can include one or more computing devices 400 or a portion of computing device 400 or some or all functionality of computing device 400.

The data processing system 150 can reside on a computing device of the utility grid 100, or on a computing device or server external from, or remote from the utility grid 100. The data processing system 150 can reside or execute in a cloud computing environment or distributed computing environment. The data processing system 150 can reside on or execute on multiple local computing devices located throughout the utility grid 100. For example, the utility grid 100 can include multiple local computing devices each configured with one or more components or functionality of the data processing system 150.

Each of the components of the data processing system 150 can be implemented using hardware or a combination of software and hardware. Each component of the data processing system 150 can include logical circuity that responds to and processes instructions fetched from a memory unit (e.g., memory 215 or storage device 225). The logical circuitry can include one or more central processing units (CPUs) or graphics processing units (GPUs). Each component of the data processing system 150 can include or use a microprocessor or a multi-core processor. A multi-core processor can include two or more processing units on a single computing component. Each component of the data processing system 150 can be based on any of these processors, or any other processor capable of operating as described herein. Each processor can utilize instruction level parallelism, thread level parallelism, or different levels of cache, for example. The data processing system 150 can include at least one logic device, such as a computing device or server, having at least one processor to communicate via the network 140.

The components and elements of the data processing system 150 can be separate components, a single component, or part of the data processing system 150. For example, individual components or elements of the data processing system 150 can operate concurrently to perform at least one feature or function discussed herein. In another example, components of the data processing system 150 can execute individual instructions or tasks. The components of the data processing system 150 can be connected or communicatively coupled to one another. The connection between the various components of the data processing system 150 can be wired or wireless, or any combination thereof. Counterpart systems or components can be hosted on other computing devices.

The data processing system 150 can communicate with one or more metering devices 118 via the network 140. In some cases, the data processing system 150 can include features or functionalities of the metering devices 118. In some other cases, the data processing system 150 can be a part of the metering device 118, such that the metering device 118 can perform certain features or functionalities of the data processing system 150. The data processing system 150 can include one or more processing units, such as a GPU, to perform local processing at a local site (e.g., grid edge or at a residential area). For purposes of providing examples herein, the data processing system 150 may be a metering device 118 or an edge device configured to perform the features or operations discussed herein (e.g., processing data locally) to perform high-resolution forecasting at relatively high sampling rate. It should be noted that, in some cases, other devices or systems at the edge of the utility grid 100 can be supported or configured to perform the features or operations discussed herein, not limited to the data processing system 150.

In some configurations, an approach for load forecasting can involve the use of measured variables available to predict the load (e.g., real and reactive power) for the residential location (e.g., at the whole-home level) during a predefined period in a future timeframe (e.g., the next hour or the next day). In certain systems discussed above, certain approaches may be hindered by relatively low sampling resolution and few input variables. The systems and methods can provide improvements to such systems, for instance, by measuring the electrical (e.g., voltage or current) waveforms for the residential location (e.g., the whole-home level) at a relatively high sampling rate (e.g., minimum sampling rate of 4 kHz or 7 kHz). The measurement can be a time series of voltage or current measurements, for example.

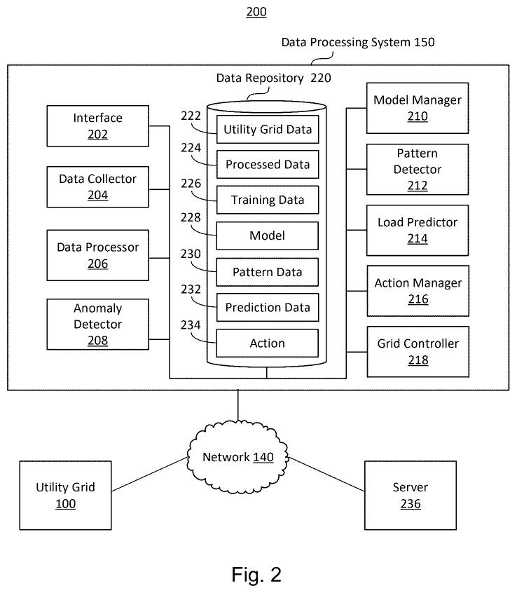

The systems and methods can provide the ability to process the waveform data (or time series) locally, e.g., by the data processing system 150, because the transmission of the waveform data to the cloud or other remote device for processing may be cost-prohibitive at scale. For instance, the waveform data measured at the predefined high sampling rate may involve excessive network resources to effectively transmit from the data processing system 150 (e.g., metering device 118 or edge device) to the cloud. The waveform data (or the time series data) can be raw data. By processing the waveform data locally, the systems and methods can reduce network traffic and resources, allow for real-time load forecasting and decision-making capabilities, enhance the responsiveness of grid controls, and increase overall operational efficiency. The various operations of the data processing system 150 (among other devices or components) for data processing and load forecasting using relatively high-resolution data or the relatively high sampling rate can be described in conjunction with but not limited to FIG. 2.

FIG. 2 illustrates a block diagram of an example system to forecast electrical or electricity load using high-resolution data. The system 200 can include, interface with, access, or otherwise communicate with at least one utility grid 100, at least one data processing system 150, at least one server 236, or other non-limiting devices (e.g., not limited to devices or components discussed herein). The data processing system 150 can include one or more components (e.g., one or more processors, memory, databases, interfaces, etc.) configured to perform features or functionalities discussed herein for high-resolution (information-rich) electricity load forecasting. The data processing system 150 can be a computing device local to or remote from the utility grid 100. The data processing system 150 can transmit or receive data to or from other components (e.g., utility grid 100 or server 236) of the system 200 via the network 140. The utility grid 100 and the network 140 can be referred to in conjunction with FIG. 1. The one or more devices, components, or systems (e.g., data processing system 150, metering devices 118, or server 236) of the utility grid 100 or the system 200 can be composed of hardware, software, or a combination of hardware and software components.

The data processing system 150 can include or correspond to at least one metering device 118, such as one of the metering devices 118 configured to perform one or more features (e.g., collect and process electricity characteristics) for predicting or forecasting electrical load on the utility grid 100. The data processing system 150 can be located within the utility grid 100. For example, the data processing system 150 can be positioned, installed, or provided at a location downstream from the substation 104 on the utility grid 100 that distributes electricity. For purposes of providing examples, the data processing system 150 can be installed or located at a grid edge, such as at a residential home or an entity.

The data processing system 150 can receive and process data locally on the utility grid 100. In some cases, the data processing system 150 can forward or delegate one or more features or functionalities to another computing device local to or remote from the utility grid 100. For instance, the data processing system 150 can transmit data to the server 236 executing in a cloud computing environment or distributed computing environment. In this case, the data processing system 150 may perform a portion of the functionalities for processing information (e.g., electrical characteristics) local to the utility grid 100 and the server 236 may perform another portion of the functionalities for processing the information (or processed data from the data processing system 150).

The data processing system 150 can include one or more components for data processing, load forecasting, electrical characteristic prediction, or executing one or more actions within the utility grid 100 (e.g., electricity distribution grid), for instance, at least one interface 202, at least one data collector 204, at least one data processor 206, at least one anomaly detector 208, at least one model manager 210, at least one pattern detector 212, at least one load predictor 214, at least one action manager 216, at least one grid controller 218, and at least one data repository 220. Each of the components (e.g., interface 202, data collector 204, data processor 206, anomaly detector 208, model manager 210, pattern detector 212, load predictor 214, action manager 216, grid controller 218, or data repository 220) of the data processing system 150 can be implemented using hardware or a combination of software and hardware. Each component of the data processing system 150 can include logical circuity (e.g., a CPU or GPU) that responds to and processes instructions fetched from a memory unit (e.g., memory 415 or storage device 425). Each component of the data processing system 150 can include or use a microprocessor or a multi-core processor. A multi-core processor can include two or more processing units on a single computing component. Each component of the data processing system 150 can be based on any of these processors, or any other processor capable of operating as described herein. Each processor can utilize instruction level parallelism, thread level parallelism, different levels of cache, etc. For example, the data processing system 150 can include at least one logic device such as a computing device or server having at least one processor to communicate via the network 140.

The components and elements (e.g., interface 202, data collector 204, data processor 206, anomaly detector 208, model manager 210, pattern detector 212, load predictor 214, action manager 216, grid controller 218, or data repository 220) of the data processing system 150 can be separate components, a single component, or part of the data processing system 150. For example, individual components or elements of the data processing system 150 can operate concurrently to perform at least one feature or function discussed herein. In another example, components of the data processing system 150 can execute individual instructions or tasks. In yet another example, the components of the data processing system 150 can be a single component to perform one or more features or functions discussed herein. The components of the data processing system 150 can be connected or communicatively coupled to one another, such as via the interface 202. The connection between the various components of the data processing system 150 can be wired or wireless, or any combination thereof. Counterpart systems or components can be hosted on other computing devices.

The interface 202 can interface with the network 140, devices within the system 200 (e.g., server 236 or utility grid 100), or components of the data processing system 150. The interface 202 can include features and functionalities similar to the communication interface of one or more metering devices 118 to interface with the aforementioned components, such as in conjunction with FIG. 1. For example, the interface 202 can include standard telephone lines LAN or WAN links (e.g., 802.11, T1, T3, Gigabit Ethernet, Infiniband), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.11a/b/g/n/ac CDMA, GSM, WiMax and direct asynchronous connections). The interface 202 can include at least a built-in network adapter, network interface card, PCMCIA network card, EXPRESSCARD network card, card bus network adapter, wireless network adapter, USB network adapter, modem, or any other device suitable for interfacing one or more devices within the system 200 to any type of network capable of communication. The interface 202 can communicate with one or more aforementioned components to receive data from at least one of the utility grid 100, the server 236, or one or more metering devices 118, such as data representative of electricity distribution to individual metering devices 118 within the utility grid 100, processed data from the server 236, or instructions from client devices in communication with the data processing system 150.

The data collector 204 can obtain or collect electrical data within the utility grid 100. The electrical data can include data samples of an electrical waveform corresponding to electricity (e.g., electrical signals) distributed at or to the location of the data processing system 150 on the utility grid 100. In various cases, the data collector 204 can receive relatively high-resolution data, such as at least 1 kHz, 7 kHz, 10 kHz, or 32 kHz of voltage data or current data. For purposes of examples herein, the electrical data discussed herein can be voltage data or current data, although other types of electrical data or metrics can be obtained, such as power electrical information.

For example, the data collector 204 can obtain electrical or electricity waveform data or a data set (e.g., voltage waveform data or current waveform data) corresponding to electricity distributed over the utility grid 100 and measured by at least one of the metering devices 118. The data processing system 150 can be in communication with the metering device 118 via the network 140 to receive the measured electrical data. The interface 202 can receive the electrical waveform data from the metering device 118 periodically or in response to the metering device 118 measuring the electricity or electrical waveform data distributed over the utility grid 100. The data collector 204 can obtain the electrical waveform data from the metering device 118 via the interface 202 in communication with the network 140.

In another example, the data processing system 150 can correspond to or include the metering device 118, including the features or functionalities of the metering device 118. The data processing system 150 (or the metering device 118) can include one or more sensors (e.g., voltage sensors) communicatively coupled with the data processing system 150 or one or more components of the data processing system 150. The one or more sensors can measure the electricity distributed over the utility grid 100 to generate the electrical waveform data, such as at least one of voltage waveform data or current waveform data. The waveform data can include or correspond to time series of electrical data, such as voltage time series or current time series.

The one or more sensors can perform the measurement at a predefined sampling rate according to their configurations or capabilities. The data collector 204 can collect the waveform data measured at the predefined sampling rate, for instance, at least 7 kHz or at least 32 kHz. The electrical data can be measured at other sampling rates, not limited to the those discussed herein.

The data collector 204 can receive the waveform data set (e.g., electrical waveform data) including characteristics of power or electricity consumption measured for a site. The site can include a grid edge, a residential home, or a location of an entity at which the data processing system 150 (or a metering device 118) is located, positioned, or installed, for example. The data collector 204 can collect or receive the waveform data set during a first time interval. The first time interval can refer to the time interval or period during which the electrical waveforms are measured or collected at a (relatively high) sampling rate (e.g., first sampling rate). The characteristics of power consumption can include at least one of voltage waveforms or current waveforms. In some cases, the characteristics of power consumption can include both voltage waveforms and current waveforms. Data collected or measured by the data collector 204 can be stored in and retrieved from the data repository 220.

The data processor 206 can process the waveform data set (e.g., the characteristics of power consumption) to determine or obtain one or more metrics of the measured power consumption. The data processor 206 can obtain the one or more metrics over at least one time interval. Each time interval can include multiple time windows, such as a first time window, a second time window, etc. For example, subsequent to the data collector 204 measuring or receiving the electrical waveforms over the first time interval, the data processor 206 can process the electrical waveforms over one or more time windows to obtain one or more respective metrics. The duration of the time windows can be configured by the administrator or operator of the utility grid 100 or the data processing system 150. The duration of the time windows can be similar to each other, such as 1 second, 5 seconds, or 10 seconds time window. The time interval can be configured by the administrator or operator of the utility grid 100 or the data processing system 150. For instance, for a 1-minute time interval, there can be 60 metrics corresponding to the respective 60 of the 1-second time windows. The metric can include or correspond to a value determined or computed using at least one statistical technique on the measurement (e.g., measured electricity distributed over the utility grid 100) over the time window. In some cases, multiple metrics can be computed or determined for each time window. The data processing system 150 (e.g., data collector 204 or data processor 206) can collect and process the waveform data set over the predefined time interval, such as but not limited to a 30-minute, 1-hour, or 2-hour time interval, for load forecasting.

The data processor 206 can process the waveform data set to obtain or determine the metrics including at least one of harmonic information or power-system values (e.g., reactive power) at a predefined resolution or sampling rate (e.g., second sampling rate). The harmonic information and the power-system values can be utilized for load forecasting. For purposes of providing examples, the data processor 206 can process the waveform data set at one second resolution (e.g., 1-second time window), although other time resolution can be configured for processing the waveform data set. The data processor 206 can process the voltage waveforms and the current waveforms separately to obtain the one or more metrics. For instance, the data processor 206 can obtain the harmonic information or power-system values based on the voltage waveforms or the current waveforms or both the voltage and current waveforms from the waveform data set.

At the predefined resolution (e.g., one second resolution), the data processor 206 can obtain statistics (or metrics), such as an average, mean, standard deviation, minimum, or maximum values of the waveform data. For example, for each time window, the data processor 206 can use statistical computation techniques to compute at least one of the minimum, average, maximum, mean, standard deviation, for example, of the time series values. The data processor 206 can store the processed information in the data repository 220, retrievable by one or more components of the data processing system 150, or in some other cases, by authorized devices in communication with the data processing system 150 via the network 140.

The harmonic information can include, but is not limited to, one or more harmonic components, such as harmonic orders, amplitudes or magnitudes associated with the respective harmonic orders, or phases associated with the respective harmonic orders. To obtain the harmonic information, the data processor 206 can perform or apply a frequency transform (e.g., Fourier Transform) to the waveform data, e.g., converting a time-domain signal to its frequency-domain representation. The Fourier Transform can output a spectrum of frequencies present in the waveform. By applying the Fourier Transform, the data processor 206 can obtain at least an amplitude or magnitude and phase of each harmonic component for the respective time window, e.g., a harmonic magnitude or phase of each harmonic component per second. The harmonic component can refer to the sinusoidal wave with frequency that is an integer multiple of the fundamental frequency (e.g., 60 Hz) of a periodic signal.

For example, the data processor 206 can obtain the 3^{rd}, 5^{th}, 7^{th} harmonics, or more, up to a predefined threshold harmonics by performing Fourier Transform of the waveform data (e.g., time series of electrical values). The harmonics are frequencies that are integer multiples of a fundamental frequency. With the fundamental frequency of 60 Hz, for example, the 2^{nd} harmonic can correspond to 120 Hz, the 3^{rd} harmonic can correspond to 180 Hz, the 4^{th} harmonic can correspond to 240 Hz, the 5^{th} harmonic can correspond to 300 Hz, etc. The data processor 206 can obtain predefined harmonics, configured or selected by the administrator or operator of the utility grid 100 or the data processing system 150. For purposes of providing examples, the data processor 206 can apply the Fourier Transform to obtain one or more odd harmonics up to a predefined threshold harmonics. In some cases, the data processor 206 can apply the Fourier Transform to obtain one or more even harmonics, in addition to or alternatively from the odd harmonic(s). The harmonics for each of the current and voltage waveforms or time series can be processed separately.

In various scenarios, certain harmonics may exhibit similar characteristics or patterns, such as similar changes in magnitude and phase, in response to power events within the utility grid 100, power consumption at the site, etc. In such cases, one of these harmonics (having similar characteristics) can be utilized as a representative for the group, to reduce computational complexity and resource consumption. For example, if one or more other order of magnitudes are similar to the 7^{th} order magnitude (e.g., magnitude of the 7^{th} harmonic), the data processor 206 can obtain and utilize the 7^{th} order magnitude without the one or more other order of magnitudes for load forecasting, e.g., skip or discard the one or more other order of magnitudes. In another example, if one or more other order of phases are similar to the 7^{th} order phase (e.g., phase of the 7^{th} harmonic), the data processor 206 can obtain and utilize the 7^{th} order phase without the one or more other order of phases for load forecasting. The data processor 206 can utilize different combinations of magnitudes and phases from different harmonics. The harmonics (or order of harmonics) to be utilized can be predefined or configured by the administrator or operator of the utility grid 100 or the data processing system 150.

The power-system values can include at least one of reactive power, real power, apparent (e.g., reactive) power, current phase angle, or other information obtained from processing the time series data, e.g., processing voltage waveforms and current waveforms. The data processor 206 can utilize one or more suitable statistical techniques to compute the power-system values. For example, in response to obtaining the voltage and current time series, the data processor 206 can obtain the phase angle between the voltage and current. The data processor 206 can compute the apparent power based on the product of voltage and current values. The data processor 206 can compute the reactive power based on the voltage, current, and sine of the phase angle, e.g., product between the apparent power and sine of the phase angle.

The data processor 206 can compute the real power based on the voltage, current, and cosine of the phase angle, e.g., product between the apparent power and cosine of the phase angle. The current phase angle can represent the phase difference between the current and the voltage at the site or another point in the utility grid 100. The data processor 206 can compute the current phase angle using any suitable phase angle formula based on the difference between the phase angles of the voltage and current phasors. The data processor 206 can process the waveform data set to obtain other statistics, not limited to the harmonic information or the power-system values.

Based on the power-system values and the harmonic information, the data processor 206 can construct a processed waveform data set having a time series of values at a predefined sampling rate (e.g., second sampling rate). For one second resolution (used to compute or obtain the power-system values and the harmonic information), the second sampling rate of the processed waveform data set can be 1 Hz. The data processor 206 can construct the processed waveform data set using other sampling rates, such as 0.5 Hz, 2 Hz, 5 Hz, 10 Hz, etc., that is less than the first sampling rate.

In some configurations, the resolution for determining the power-system values and the harmonic information may be different from the sampling rate for constructing the processed waveform data set. For example, the data processor 206 may determine respective power-system values and harmonic information at a relatively higher resolution (or rate) compared to the second sampling rate. If the power-system values and harmonic information are determined at a 0.5-second resolution, and the sampling rate is set to 1 Hz, the data processor 206 can construct the processed waveform data set by using every other value (e.g., every two values) of the power-system data and harmonic information. For example purposes and to minimize computational resources, the second sampling rate can match the resolution at which the power-system values and harmonic information are determined. The processed waveform data set can be stored in the data repository 220. Changes to the power-system values and harmonic information can be representative of transient changes in the electrical signals distributed over the utility grid 100 or electrical consumption at the site.

The data processor 206 can generate statistical metrics based on the harmonic information. The statistical metrics can include at least one of total harmonic distortion (THD), harmonic mean, individual harmonic distortion (IHD), crest factor, interharmonics, or total demand distortion (TDD), derivative of power, range of power, range of reactive power, among others. The data processor 206 can compute the statistical metrics by applying any suitable computational techniques on at least a portion of the harmonic information. The data processor 206 can store the statistical metrics in the data repository 220.

The anomaly detector 208 can detect one or more anomalies in the waveform data set based on the statistical metrics. For example, the anomaly detector 208 can receive or retrieve indications of expected harmonic patterns. The expected harmonic patterns can include at least one of ranges of values, minimum values, maximum values, etc. The anomaly detector 208 can compare one or more statistical metrics, generated based on the harmonic information, to the expected harmonic patterns. For instance, the anomaly detector 208 can compare the generated THDs with a THD threshold (e.g., maximum THD). The anomaly detector 208 can remove or filter at least a portion of the waveform data set associated with the THDs greater than (or equal to) the THD threshold. The anomaly detector 208 can compare the generated harmonic means with expected range of harmonic means. The anomaly detector 208 can remove at least a portion of the waveform data set associated with the harmonic means outside of the expected range.

In further examples, the anomaly detector 208 can compare the generated IHDs with expected IHD range, and remove at least a portion of the waveform data set associated with IHDs outside the expected IHD range. The anomaly detector 208 can compare the generated crest factors with a crest factor threshold, and remove at least a portion of the waveform data set associated with the crest factors at or above the crest factor threshold. The anomaly detector 208 can detect non-integer multiples of the fundamental frequency based on the interharmonics to perform anomaly removal. The anomaly detector 208 can utilize the TDDs to detect unexpected or abnormal changes in power consumption patterns. The anomaly detector 208 may remove at least a portion of the waveform data set associated with the TDDs indicative of abnormal power consumption patterns.

The anomaly detector 208 can remove other detected anomalies from the waveform data set. Removing anomalies from the waveform data set can include removing one or more power-system values or a portion of the harmonic information. The anomaly detector 208 can signal the data processor 206 that the anomalies are removed. The data processor 206 can construct the processed waveform data set based on the power-system values and the harmonic information with the anomalies removed.

The model manager 210 can manage one or more models to predict the characteristic of the load at the site during a second time interval. The second time interval can refer to a time interval subsequent to or occurring after the first time interval during which the waveform data set is obtained. The models can include, but are not limited to, at least one of a convolution neural network (CNN), a recurrent neural network (RNN) architecture, a linear regression model or technique, a decision tree architecture, a support vector machine, among others. The RNN architecture may include but is not limited to a long short-term memory (LSTM) model. The linear regression model may include but is not limited to an autoregressive moving average model.

The models can be stored in the data repository 220. In some cases, the model manager 210 can retrieve one or more models from an external database, such as from the server 236, a remote system, or a cloud computing device. In some other cases, the model manager 210 can receive the models from the one or more metering devices 118. The model manager 210 can receive updated models or training data for the models from the server 236. The model manager 210 can train the one or more models locally, for instance, training a base model based on local data processing or provided training data. The model manager 210 may broadcast, distribute, or send the trained models to the one or more metering devices 118 or other authorized devices within the network 140. The model manager 210 can provide the collected or processed data to the one or more metering devices 118. The collected or processed data can be used by the other metering devices 118 for training or validating the local models.

The model manager 210 can manage or train multiple models to be utilized in a two-step or stage model or technique for accurate short-term load prediction, for example. The model manager 210 can use (pre-) processed data (e.g., referred to as training data) to train the model. The data can include historical statistics of the waveform data or time series data. Preprocessing the data can involve normalizing the data and splitting the normalized data into at least training data set, validation data set, and testing data set. The training data set can be used for training the model. The validation data set can be used to tune parameters of the model, for example, to reduce overfitting. The testing data set can be used to evaluate the model output. Anomalies can be removed from the training data prior to initiating the training procedure.

For example, the model manager 210 can train at least one model (e.g., CNN) to identify or detect signatures or patterns via extrapolation, e.g., using CNN for feature engineering. The training procedure may involve feeding the model a training data set containing at least labeled examples of the signatures or patterns. The model can use the training data set to learn the distinguishing features and characteristics of the patterns. During training, the model manager 210 can adjust the parameters of the model through iterative optimization techniques, such as gradient descent, among others, to minimize the error between the model output and the actual labels (e.g., predefined labels for training purposes). The model manager 210 can verify the model based on the differences or errors between the model output and the expected results being below a threshold. In other words, the model manager 210 can verify that the model is trained when the output accuracy is at or above an accuracy threshold.

In some implementations, the CNN can be trained manually (e.g., supervised training). In some cases, the CNN can be trained unsupervised. The output from the CNN can be a vector, e.g., time series feature vector (or additional extracted features). The CNN can learn to identify different patterns or signatures and output vectors at different points in time indicating the intensity of the signature presented or identified in the data. Types of events associated with the pattern or signature may or may not be identified according to the configuration of the data processing system 150 or other devices discussed herein.

Once trained, the one or more components of the data processing system 150 can utilize the model for its intended purpose, such as for identifying or detecting patterns. The signatures (or patterns) may be derived from electrical data. In some cases, the patterns can include or correspond to features generated for various purposes, e.g., machine learning (ML) purposes (e.g., outputs of an independent component analysis (ICA) performed on the original input data). The patterns can include at least one of, but not limited to, spikes or dips, consistency or inconsistency, increase or decrease (e.g., ramp pattern), rate of change, stability, repetition or irregular fluctuation, periodic pattern, or step changes in the data (e.g., the time series of values), such as at least one of the power-system values or harmonic information in the processed waveform data set. The patterns may represent certain changes in the power consumption at the site or events occurred in the utility grid 100. It should be noted that the patterns can include or correspond to other types of features, not limited to the derivative of electrical data or features generated for ML purposes.

In further examples, the model manager 210 can train a time series forecasting model to perform the prediction or forecasting. The time series forecasting model can be referred to a forecasting model used at the second stage of the two-stage model, for example. The forecasting model can be utilized by the load predictor 214 to perform load prediction, e.g., forecasting a total load at least a subsequent time interval (e.g., the second time interval). The forecasting model can include or correspond to the RNN architecture, such as an LSTM model, a linear regression model, such as an autoregressive moving average model, or a decision tree architecture, among others. Taking the RNN architecture as an example of the forecasting model, the model manager 210 can train the RNN architecture to predict the load characteristics (e.g., total load) at the site during the second time interval. The model manager 210 can feed training data for the RNN architecture. The training data can include historical load data and historical patterns associated with the historical load data. The RNN architecture can learn different historical patterns and their connections or relations to the associated historical load characteristics. Similar to other models, the model manager 210 can validate the RNN architecture using validation data set and evaluate the performance of the RNN architecture using test data set to improve and provide models with a desired accuracy. The model manager 210 can deploy verified and evaluated models for high-resolution load forecasting or prediction. The model manager 210 can train other models to perform load forecasting. In some cases, one or more other techniques can be utilized to perform the load forecasting or prediction of the load characteristics.

In some cases, the forecasting model and the CNN can be trained together. For instance, the data set (e.g., processed waveform data set) of the one second resolution time series features extracted from the voltage and current time series can be used as inputs to the models, including the power-system values and the harmonic information as a time series of values, for example. In response to processing the processed waveform data set, forecasting the model can output the total load forecasted throughout a predefined time interval or duration (e.g., one hour). The output from the model (e.g., forecasted total load) can be used for training or iterative training purposes. The actual total load associated with the forecasted time can be part of the training data. In such cases, the model manager 210 can compare the output of the forecasting model with the actual (historical) load from the training data set for or during the predicted time interval. In response to performing the comparison, the model manager 210 can obtain the accuracy (or error) output by the model(s). In the case of obtaining erroneous outputs (e.g., the difference between the prediction and the actual load greater than or equal to a predefined threshold), the model manager 210 can perform gradient descent against the trained layers of the model (e.g., for iterative training). The gradient descent can refer to a technique which iteratively update model parameters to minimize prediction error. In some implementations, other techniques to minimize prediction error and improve output accuracy may be utilized. The model manager 210 can minimize the error between the ground truth and output of model via feedback loop, for example. In some configurations, the forecasting model and the CNN can be trained independently.

As a first stage of the two-stage model, the pattern detector 212 can detect patterns in the time series of values of the processed waveform data set, constructed based on the power-system values and the harmonic information. The pattern detector 212 can utilize a CNN or other types of neural network or models for purposes of pattern detection. The CNN can be trained by the model manager 210 or received from external devices via the network 140. The pattern detector 212 can feed the processed waveform data set as input to the CNN. Using the CNN, the pattern detector 212 can detect patterns in the time series of the processed waveform data set. The output from the pattern detector 212 or the model can include the detected patterns or features to be fed to the next stage of the two-stage model. The patterns can include but are not limited to at least one of values within a predefined range (in the time series of values), derivatives of the metrics with a predefined range, one or more combinations of values, or derivatives between the metrics to produce distinct patterns (e.g., indication of relatively high power or indication of relatively low reactive power).

In some configurations, the pattern detector 212 may receive weather data, geographical data, or other environmental information as inputs for training the CNN model to recognize the pattern. Other data can be provided for training the CNN, such as but not limited to at least one of the EV charging schedule, time periods when an EV is connected to a charger, power storage capacity, power generation capability at the site (e.g., the number or capabilities of the photovoltaic (PV) panels, determined in combination with the weather information), etc.

As a second step (or stage), the load predictor 214 can use the time series forecasting model (e.g., forecasting model) to predict future values (e.g., perform forecasting) according to or based on historical or past values used to train the forecasting model. For example, the load predictor 214 can feed or input at least the patterns (or signatures or features) generated or detected in the first stage to the forecasting model. The load predictor 214 can feed at least a portion of the processed waveform data set (e.g., at least a portion of the time series of values) associated with the patterns to the forecasting model. For purposes of providing examples, the forecasting model can be the RNN architecture, although other types of models, techniques, or architectures can be utilized by the load predictor 214 to perform the prediction, including but not limited to the linear regression technique or decision tree architecture.

Based on the training conducted on the model, the forecasting model can analyze or process the processed waveform data set or the patterns of the processed waveform data set (among other information associated with the site), such as correlate the patterns of the processed waveform data set and historical total load, e.g., the characteristics of load, during the second time interval. In response to the forecasting model processing at least the processed waveform data set, the forecasting model can generate an output (e.g., forecasted or predicted values). In various configurations, the forecasting model can receive other types of input data, such as exogenous data (e.g., weather condition, temporal variables, or solar irradiance which affects solar panel power generation), to perform the prediction or forecasting. The output from the forecasting model can include the total load for the second or subsequent time interval (or various other timeframes) or other load characteristics, for example. For example, the predicted total load for the second time interval may resemble or follow similar trends as the historical total load recorded after detecting similar patterns. The predicted total load may include different magnitude or amplitude compared to the historical total load, for instance, based on at least one of the average, minimum, maximum, other statistical metrics, power-system values, or harmonic information determined, measured, or recorded at the site, which may differ from the historical total load from other sites.

The load predictor 214 can input or feed temporal variables to the forecasting model, including but not limited to at least one of the day, season, etc., such that the forecasting model can expect certain types of patterns or signatures when performing the forecasting. The load predictor 214 can input other types of information to the forecasting model to output characteristics of the load (e.g., magnitude, stability, load type, or duty cycle, for example) at the site during the second time interval, not limited to the information discussed herein. The load predictor 214 can obtain the output from the forecasting model, including predicted load for a predefined future time period, such as the loads in a predefined resolution (e.g., one data point per 1 minute or 5-minutes) within the next hour (e.g., short-term prediction). In some cases, the data processing system 150 (e.g., interface 202 or action manager 216) can transmit or upload the prediction to the cloud, the remote computing device, or the server 236 for power generation or load management. In some cases, the data processing system 150 (e.g., interface 202 or grid controller 218) may send the prediction to the grid operator or an administrator device to control the grid operation.

The load predictor 214 can utilize models, techniques, or architectures in addition to or different from the RNN architecture to predict the characteristic of the load. For example, the load predictor 214 can predict the characteristic of the load at the site during the second time interval using the linear regression technique. The linear regression (technique) can model linear relationships between the inputs and the forecasted load, e.g., trained using historical data. Using the RNN architecture can involve modeling linear or non-linear relationships between the inputs and the forecasted load. In some cases, the load predictor 214 can predict the characteristic of the load using the decision tree architecture. The decision tree (or architecture) can model the relationships between the inputs and the forecasted load using categorical classification process from the training of the decision tree model.

In various configurations, the model manager 210 can continuously improve or iteratively train the model with incoming data, e.g., compare the prediction (e.g., predicted load) of the second time interval to incoming data (e.g., actual load) measured during the second time interval, responsive to data measurement. For example, the data collector 204 can obtain a second waveform data set including the characteristics of power consumption (e.g., voltage waveforms and current waveforms) measured for the site during the second time interval at the first sampling rate. The data processor 206 can determine a characteristic of the load based on the second waveform data set or a second processed waveform data set determined based on power-system values and harmonic information of the second waveform data set. The model manager 210 (or the data processor 206) can compare the characteristic of the load based on the second waveform data set with the characteristic of the load predicted during the second time interval, e.g., comparing the actual load characteristic and the predicted load characteristic. Based on the comparison (e.g., similarities or differences) between the predicted load characteristic from the actual load characteristic, the model manager 210 can update the one or more models to improve the load characteristic prediction based on the detected patterns. The data processing system 150 may repeat the training process for subsequent time intervals.

In some cases, the model manager 210 can update the model periodically, such as daily, weekly, or based on another time interval. In some cases, the model manager 210 may receive training data from one or more metering devices 118 executing local models or from the server 236 to re-train or update the one or more models. In some cases, the model manager 210 can receive pre-trained model from the server 236. In some aspects, the model manager 210 may train the one or more models using local data measured or recorded at the site, without external training data.

In some configurations, the short-term prediction can be utilized together with a long-term prediction. The short-term prediction can refer to predictions performed for the next hour, next two hours, etc. The long-term prediction can refer to predictions performed for the next day, week, or other time interval that is longer than the short-term prediction. For instance, the long-term prediction can be for system planning, long-term scheduling, making control decisions (e.g., changing a tap setting on a voltage transformer), or other management operations. The short-term prediction can be for at least DER dispatch, e.g., using high resolution, high accuracy information to provide relatively frequent or fast response. In various configurations, one or more operations discussed herein for executing the long-term forecasting, such as training and executing one or more models for long-term forecasting can be utilized or performed for short-term forecasting (e.g., having a relatively higher resolution and granularity compared to the long-term forecasting). In some cases, different types of information can be utilized in the short-term forecasting compared to the long-term forecasting. In some other cases, similar types of information (e.g., with different resolution) may be utilized in the short-term forecasting compared to the long-term forecasting. For instance, in short-term forecasting, a relatively more recent load information can be utilized, and techniques with relatively less complexity or resource intensity can be executed (with similar accuracy), compared to the long-term forecasting. One example short-term-forecasting technique can be naïve prediction, which may not be utilized for long-term forecasting, for example. Other types of short-term forecasting techniques or long-term forecasting techniques can be utilized, not limited to those discussed herein.

The action manager 216 can manage one or more actions to be performed on the utility grid 100 or at the site (e.g., by the user at the residential home). The action manager 216 may select one or more actions to be executed by the grid controller 218. The action can include but is not limited to at least one of power delivery adjustment to the site, sending notification or information to the server 236, at least one grid device, or a client device of a user at the site, DER dispatch, adjusting tap settings, or managing charging infrastructure. For example, the action manager 216 can compare the characteristic of the load, such as total load, predicted during the second time interval with a threshold. If the characteristic of the load satisfy (e.g., greater than or equal to) the threshold, indicating a prediction of an excessive total load at the site, the action manager 216 (or the grid controller 218) can execute an action including transmitting a notification of the comparison (e.g., results of the comparison) to the server 236 remote from the data processing system 150. The notification can inform the administrator or operator of the server 236 of the excessive total load, for instance, to perform load balancing. In some cases, satisfying the threshold can involve the characteristic of the load being below the threshold, indicative of a predicted power outage, for example. In such cases, the notification can inform the administrator or operator of the server 236 of the potential power outage, such that tap setting can be adjusted or a maintenance team can be preemptively dispatched, for example.

In another example, the action manager 216 can determine whether the power delivery to the site is sufficient based on a comparison between the predicted characteristic of the load and the power delivery supplied by the grid. In some cases, if the site is predicted to use an excessive amount of power, the action manager 216 can select an action related to power delivery for the site based on the characteristic of the load predicted during the second time interval. The action related to the power delivery can include DER dispatch. The action can be executed by the grid controller 218.

For example, the DER dispatch can involve load balancing, such as adjusting the power generation at the grid edge, voltage control, frequency regulation, etc., to satisfy power consumption demands predicted. In response to the predicted an excess power consumption, the grid controller 218 can communicate with the utility grid 100 or devices within the utility grid 100. The grid controller 218 can command or control one or more grid devices or provide instructions to the grid devices, such as managing power flow, load shedding, voltage regulation, fault detection and isolation, integration of renewable energy sources, demand response, etc. The grid controller 218 can request additional power generation or adjust the distribution of electrical power to the site at least for the second time interval, for example. In some cases, commanding the grid device can include adjusting the tap setting. Adjusting the tap setting can involve modifying the settings on transformers to regulate voltage levels across the grid, for example.

In some cases, the action manager 216 can manage actions for the charging infrastructure, including controlling the charging rate of EV or other battery storage systems at the site to balance load and prevent grid overload, such as for charging infrastructures at the sites authorized to perform the adjustments. Based on the predicted load characteristic, the action manager 216 can select at least one suitable action to manage the charging infrastructure. The selected action can be executed or performed by the grid controller 218. For example, the grid controller 218 may provide commands to the charging infrastructure in response to detecting the excess power consumption, in some cases, with authorization by the user at the site. The grid controller 218 may provide a notification to the client device associated with the site for the user to approve or deny changes to the charging infrastructure settings. The action manager 216 may manage other actions based on the predicted load characteristic. If the predicted load characteristic does not satisfy the threshold, the action manager 216 may not select an action to perform, and the data processing system 150 can continue monitoring the power consumption at the site.

The data repository 220 can may be referred to as a data storage, database, memory device, etc. The data repository 220 can include at least a utility grid data storage 222, a processed data storage 224, a training data storage 226, a model storage 228, a pattern data storage 230, a prediction data storage 232, and an action storage 234. The data repository 220 can include other types of storage to store information for load prediction or forecasting. In some cases, information stored in the data repository 220 can be uploaded to or synced with the data storage of the server 236, among other cloud storage devices, or downloaded to the data repository 220 for processing. In some other cases, the information stored in the data repository 220 may be local to data processing system 150 at the site. The data repository 220 can be accessed by one or more components (e.g., data collector 204, data processor 206, anomaly detector 208, model manager 210, pattern detector 212, load predictor 214, action manager 216, or grid controller 218) of the data processing system 150, or at least one external or remote device, such as other metering devices 118 within the utility grid 100, or the server 236, for example.

The utility grid data storage 222 can include, store, or maintain information related to the utility grid 100 obtained, measured, or detected by the data processing system 150 (e.g., interface 202 or data collector 204). For example, the utility grid data storage 222 can store electrical data received or measured by the data collector 204, such as waveform data set, including voltage waveforms and current waveforms measured by the data processing system 150. The utility grid data storage 222 can store timestamps of when the data are logged or stored in the data repository 220. In some cases, the utility grid data storage 222 can include the identifier of the data processing system 150 (or metering device 118 at the site), for instance, to be provided to the server 236 during data transmission. In some other cases, the utility grid data storage 222 can include the geographical location of the data processing system 150 (or the metering device 118).

The processed data storage 224 can include, store, or maintain the data processed by the data processing system 150 (e.g., data processor 206). The processed data can include at least one of power-system values, harmonic information, transient change information, or other information obtained by processing the waveform data set. The processed data can include the processed waveform data set constructed based on at least the harmonic information and the power-system values. The processed data may include waveform data set that is removed of anomalies. The processed data storage 224 can be accessed by one or more components of the data processing system 150, such as the data processor 206, anomaly detector 208, for example.

The training data storage 226 can include, store, or maintain training data for training the model. The training data storage 226 can be accessed by the one or more components of the data processing system 150, such as the model manager 210 for updating or training the models or the load predictor 214 for executing the one or more models. The training data can include historical waveform data, historical patterns, historical load characteristics, historical statistical metrics, labels, or other historical information measured or processed by the data processing system 150 or other devices sharing data with the data processing system 150. The training data stored in the training data storage 226 can be updated by the data processing system 150. The training data stored in the training data storage 226 may be updated with additional training data from other metering devices 118 or with measurements from subsequent time intervals.

The model storage 228 can include, store, or maintain at least one model generated, trained, or managed by the model manager 210. For example, the model storage 228 can store a model generated by the model manager 210. The model storage 228 can be accessed by the model manager 210 to train or update the model. In some cases, the model storage 228 can delete at least one model based on a command from the data processing system 150 or the model manager 210. The model storage 228 can be accessed by the load predictor for the two-stage model to perform load forecasting (e.g., short-term or long-term forecasting). The model storage 228 can store one or more models generated or trained by the data processing system 150, the server 236, or other metering devices 118. The model storage 228 can store other information or data related to the model, such as the configuration, different types of models, types of ML techniques used to train individual models, model versions, last updated date, etc.

The pattern data storage 230 can include, store, or maintain information related to the patterns (e.g., pattern data or signature data) to be detected by the pattern detector 212. Patterns can refer to or include signatures that are detectable in the data. The pattern data can include types of pattern to be detected, types of information associated with the pattern, such as patterns of the harmonic information, power-system values, voltage waveforms, or current waveforms, etc. The pattern data can be updated by the administrator or operator of the server 236 or the utility grid 100. The pattern data storage 230 may receive and store additional patterns or updated patterns from the server 236. In some cases, the data processing system 150 (e.g., pattern detector 212) may identify and store new patterns or data related to the pattern.

The prediction data storage 232 can include, store, or maintain the predictions or forecasted data output by the forecasting model or by the load predictor 214. The prediction data can include, for example, at least total load during various time intervals (e.g., second time interval). The prediction data can include other information related to the prediction, such as time stamps, time intervals, estimated accuracy, associated weather condition, type of prediction (e.g., short-term or long-term prediction), action executed based on the prediction provided, etc.

The action storage 234 can include, store, or maintain various actions selectable by the action manager 216 or executable by the grid controller 218. The actions can include or correspond to executable codes, instructions, or commands for execution by the grid controller 218. The actions can be predetermined by the operator or the administrator of the utility grid 100 or the user at the site. For example, the data processing system 150 may receive the predefined actions from the server 236 or a grid device (e.g., administrator device) to store locally in the action storage 234. The action storage 234 can store new or updated actions upon receiving the actions. The action storage 234 can remove at least one predefined action responsive to a command from the server 236 or the grid device. In some cases, the action storage 234 can store similar types of actions as those stored in other metering devices 118 (e.g., the actions synched to other systems or devices). As discussed herein, the action can include providing notification to other devices, such as the server 236, the client device at the site, or the grid device. The notification can indicate the prediction result (e.g., total load forecasted) or a comparison between the predicted total load and the predefined threshold. The action can include DER dispatch, involving managing or optimizing DERs, such as tap setting adjustment, managing charging infrastructure settings, adjusting power generation by the utility grid 100, or other grid operations. The action can include other types of actions related to power delivery for the site, e.g., power delivery adjustment.

The server 236 can be remote from the data processing system 150. The server 236 may be remote from the utility grid 100 and the metering devices 118. In some implementations, the server 236 can perform or execute one or more features described in conjunction with the data processing system 150 or the metering device 118, such as collecting electrical data, processing data, training the model, performing load forecasting, etc. The server 236 can receive data from the one or more metering devices 118 or the data processing system 150. In some cases, the server 236 can perform a portion of the tasks delegated by the data processing system 150. For instance, the server 236 can receive the processed waveform data set from the data processing system 150. The server 236 can predict the characteristic of the load using one or more models stored on the server 236. The server 236 can provide the prediction results to the data processing system 150 or one or more metering devices 118. In some cases, the server 236 can broadcast the one or more models for the data processing system 150 and the one or more metering devices 118 to use. In some aspects, metering devices 118 in different geographical areas can use different types of models or versions of the models.

In view of the aforementioned, the systems and methods of the technical solution discussed herein can utilize the high-resolution data sampling including granular information on the loads, which may be lost at lower resolutions. The systems and methods can obtain the harmonic information, power-system values, or other statistical information from the voltage and current waveforms (e.g., directly), which provides a richer input data set for improving accuracy in forecasting. The operations of the technical solution discussed herein can be performed by at least one of the one or more components of the data processing system 150, the one or more metering devices 118, among other devices within the system 200 or the utility grid 100 located at a site. It should be noted that the example operations, techniques, or implementations discussed herein are non-limiting.

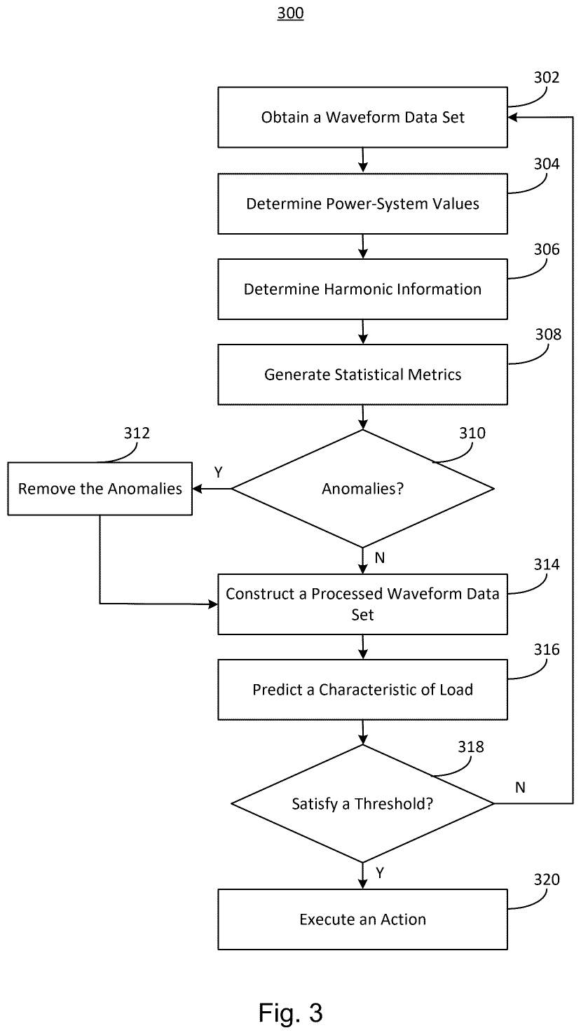

FIG. 3 is an example flow diagram of a method 300 for high-resolution electricity load forecasting. The example method 300 can be executed, performed, or otherwise carried out by one or more components of the utility grid 100 (e.g., computing device, metering devices 118, data processing system 150, etc.), the system 200 (e.g., data processing system 150, server 236, etc.), or computing device 400, etc. Although the data processing system is described herein to execute or perform the method 300, other metering devices or the server can perform similar features or functionalities as the data processing system to perform the method 300. The method 300 can include obtaining a waveform data set, at ACT 302. At ACT 304, the method 300 can include determining power-system values. At ACT 306, the method 300 can include determining harmonic information. At ACT 308, the method 300 can include generating statistical metrics. At ACT 310, the method 300 can include determining whether there are anomalies. At ACT 312, the method 300 can include removing the anomalies. At ACT 314, the method 300 can include constructing a processed waveform data set. At ACT 316, the method 300 can include predicting a characteristic of load. At ACT 318, the method 300 can include determining whether the characteristic of the load satisfy a threshold. At ACT 320, the method 300 can include executing an action.

At ACT 302, a data processing system (e.g., metering device) located at a site can obtain or receive a waveform data set. The waveform data set can include characteristics of power consumption measured for or at the site during a first time interval at a first sampling rate. The characteristics of power consumption can include voltage waveforms and current waveforms. The waveforms can correspond to time series values, such as voltage time series and current time series. The data processing system can measure the waveforms at the site at the first sampling rate. In some cases, the first sampling rate can be at least 7 kHz. In some other cases, the first sampling rate can be at least 32 kHz. With the relatively high sampling rate, the data processing system can capture transient changes in the electrical signals or waveforms distributed over the utility grid or electrical consumption at the site. The data processing system can utilize the transient changes to perform accurate load forecasting.

At ACT 304, the data processing system can determine power-system values based on the waveform data set. The power-system values can include at least one of reactive power, real power, or apparent power, among others. The data processing system can determine the power-system values by using one or more suitable computation techniques on the waveform data set. For example, the data processing system can determine the real power (P) using a real power formula, based on the root mean square (RMS) voltage, RMS current, and power factor. The data processing system can determine the reactive power (Q) using a reactive power formula, based on the RMS voltage, RMS current, and sine of the phase angle between voltage and current. The data processing system can determine the apparent power(S) based on a product of the voltage and current, for example. The data processing system can utilize other computation techniques or formula for other types of power-system values.

At ACT 306, the data processing system can determine harmonic information based on a frequency transform performed on the waveform data. For example, the data processing system can apply a Fourier Transform on the waveform data set to obtain the harmonic information. The harmonic information an include at least magnitude and phase information for one or more harmonic orders. In some cases, the harmonic information may be referred to as harmonic components, including the frequencies of the harmonic orders and the magnitudes and phases associated with the harmonic orders. The data processing system can determine the harmonic information for voltage waveforms and current waveforms individually (or separately).

At ACT 308, the data processing system can generate statistical metrics based on the harmonic information. In this case, the statistical metrics of the harmonic information can include, but are not limited to, at least one of THD, harmonic mean, IHD, crest factor, interharmonics, or TDD, to name a few. The data processing system can compute the statistical metrics by applying any suitable computational techniques on at least a portion of the harmonic information.

The data processing system can utilize the statistical metrics for anomaly detection in the waveform data set. For example, the data processing system can receive indications of expected harmonic patterns, including at least one of ranges of values, minimum values, maximum values, etc. The data processing system can compare one or more statistical metrics, generated based on the harmonic information, to the expected harmonic patterns to determine whether the values of the statistical metrics are within or outside the expected range, below a minimum threshold, above a maximum threshold, etc.

At ACT 310, the data processing system can determine whether there are anomalies within the waveform data set (or within the power-system values or harmonic information) based on the comparison between the statistical metrics and the expected harmonic patterns. If the values of the statistical metrics are outside the expected range, below the expected minimum threshold, or above the expected maximum threshold, for example, the data processing system can determine that there are anomalies in the waveform data set. In such cases, the data processing system can proceed to ACT 312. Otherwise, if the values are within the expected range or thresholds (e.g., below the maximum threshold or above the minimum threshold), the data processing system can determine that there are no anomalies in the waveform data set. The data processing system can proceed to ACT 314, in this case.

At ACT 312, the data processing system can remove the anomalies from the waveform data set. Based on the detected anomalies in the waveform data set, the data processing system can remove or discard at least a portion of the waveform data set or at least a portion of the harmonic information or power-system values associated with the detected anomalies. The data processing system can proceed to ACT 314 in response to or after removing the anomalies from the waveform data set.

At ACT 314, the data processing system can construct a processed waveform data set based on the power-system values and the harmonic information. The processed waveform data set can have a time series of values (e.g., values of the power-system values and the harmonic information) at a second sampling rate. The second sampling rate can be less than the first sampling rate. For instance, the first sampling rate may be relatively high to capture the electrical waveforms. The data processing system can process the waveforms in a plurality time windows at a predefined time resolution, such as one second resolution (e.g., second sampling rate).

For each one second resolution, the data processing system can determine a respective magnitude and phase of each harmonic order and the power-system values in the time window. Subsequent to determining the harmonic information and power-system values at the one second resolution, the data processing system can construct the processed waveform data set at the second sampling rate. In some cases, the data processing system can remove at least a portion of the waveform data set, at least a portion of the harmonic information, or at least a portion of the power-system values associated with the detected anomalies. In such cases, the data processing system can construct the processed waveform data set with the anomalies removed.

At ACT 316, the data processing system can predict a characteristic of load at the site during a second time interval based on the processed waveform data set and using one or more models. Different models can be utilized for different purposes. In some cases, the data processing system may use the same models for the load forecasting. In some other cases, the data processing system can use multiple models for different stages of the load forecasting. The one or more models can include, but are not limited to, a CNN, a RNN architecture (e.g., LSTM model), a linear regression technique or model (e.g., an autoregressive moving average model), or a decision tree architecture. It should be noted that the data processing system can utilize one or more other models, techniques, or architectures for purposes of forecasting the characteristic of the load at the site.

For example, to predict the characteristic of the load at the site during the second time interval, the data processing system can detect patterns (or signatures) in the processed waveform data set using the one or more models. To detect the patterns, the data processing system may use the CNN. The CNN can be trained using historical data (e.g., historical processed waveform data set), labeled for the CNN to learn different types of patterns. The data processing system may or may not identify the types of events associated with the pattern or signature.

The data processing system can use the patterns as inputs into the one or more models to predict the characteristic of the load at the site during the second time interval. For instance, the data processing system can input the patterns into the RNN architecture, trained to correlate patterns to expected characteristic of the load (e.g., power consumption) based on historical patterns and historical loads at the site (or at other sites). In some cases, the data processing system can utilize the linear regression technique to predict the characteristic of the load at the site during the second time interval. In some other cases, the data processing system can utilize the decision tree architecture to predict the characteristic of the load at the site during the second time interval. The predicted characteristic of the load can include the total load during the second time interval. The predicted total load can be a value or a time series of values for the duration of the second time interval.

At ACT 318, the data processing system can compare the characteristic of the load predicted during the second time interval with a threshold. The threshold may be a maximum threshold indicative of an excessive power consumption or relatively high power demand, for instance, when the predicted total load is at or above the threshold. In some cases, the threshold may be a minimum threshold indicative of a power outage or grid anomalies. If the characteristic of the load satisfy the threshold, such as greater than or equal to the maximum threshold or less than or equal to the minimum threshold, the data processing system can proceed to ACT 320. Otherwise, if the characteristic of the load does not satisfy the threshold, the data processing system may return to ACT 302 to obtain or collect additional waveform data sets in subsequent time intervals.

In some aspects, the data processing system can determine that the characteristic of the load satisfy the minimum threshold if the predicted total load is greater than the minimum threshold. In this case, the data processing system can determine that there are power consumption activities at the site, and proceed to ACT 320 to execute actions related to power delivery for the site, for example.

At ACT 320, the data processing system can execute an action related to power delivery for the site based on the characteristic of the load predicted during the second time interval. For example, based on the characteristic of the load, such as predicted increases or decreases to the total load at the site during the second time, the data processing system can execute an action including DER dispatch. For instance, the data processing system can inform the utility grid of the predicted power consumption at the site, such that the utility grid (or power source) can increase or decrease electricity generation to accommodate the predicted power consumption during the second time interval.

In another example, the data processing system may adjust the tap settings, adjust the electricity distribution to the site (e.g., increase or decrease the amount), or in some cases, send a notification to a client device associated with the site. Sending the notification to the client device may involve notifying the user of excessive power consumption, recommending the user to reduce power consumption or adjust the settings of the charging infrastructure at the site (e.g., reduce EV charging rate), or controlling the charging infrastructures or other electrical system at the site, for example.

In some cases, based on the comparison between the characteristic of the load and the threshold, e.g., greater than or equal to the maximum threshold, the data processing system can execute an action including transmitting a notification of the comparison to a server remote from the data processing system. The notification can include the predicted total load during the second time interval. The notification may include one or more commands, such as to DER dispatch for load balancing or adjusting electricity allocation to the sites for at least the second time interval. The notification can include other information to inform the server of the characteristic of the load.

In certain aspects, the data processing system can compare the characteristic of the load to a minimum threshold. If the total load falls below the minimum threshold, the data processing system may interpret the characteristic as a power outage. The data processing system can provide a notification to the server informing the predicted power outage. In some cases, the server can communicate with the utility grid to adjust grid devices to prevent the potential power outage. In some other cases, the server may notify the dispatch or maintenance team to proactively prepare for restoring power, for example.

The data processing system can continuously improve or update the one or more models. The data processing system can iteratively update or train the one or more models. For example, the data processing system can obtain a second waveform data set. The second waveform data set can include the characteristics of power consumption measured for the site during the second time interval at the first sampling rate, e.g., actual power consumption during the second time interval. The data processing system can determine a characteristic of the load based on the second waveform data set, such as based on harmonic information and power-system values determined using the second waveform data set. The data processing system can compare the characteristic of the load (e.g., measured load characteristic) based on the second waveform data set with the characteristic of the load predicted during the second time interval (e.g., predicted load characteristic). Based on the comparison, the data processing system can update the one or more models. For example, the data processing system can update the one or more models according to the differences between the actual and predicted load characteristic, correlating the patterns detected in the processed waveform data set to the actual load characteristic. Over time, the data processing system can minimize differences or errors between the predicted and actual load characteristics via iteratively training the one or more models.

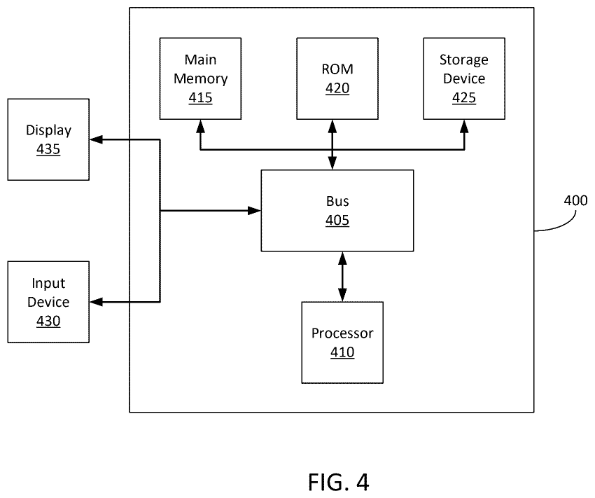

FIG. 4 is a block diagram of an example computer system 400. The computer system or computing device or system 400 can include or be used to implement the data processing system 150, or its components such as the data processing system 150. The computing system 400 includes at least one bus 405 or other communication components for communicating information and at least one processor 410 or processing circuit coupled to the bus 405 for processing information. The computing system 400 can also include one or more processors 410 or processing circuits coupled to the bus for processing information. The computing system 400 also includes at least one main memory 415, such as a random access memory (RAM) or other dynamic storage devices, coupled to the bus 405 for storing information, and instructions to be executed by the processor 410. The main memory 415 can also be used for storing position information, utility grid data, command instructions, device status information, environmental information within or external to the utility grid, information on characteristics of electricity, or other information during execution of instructions by the processor 410. The computing system 400 may further include at least one read only memory (ROM) 420 or other static storage device coupled to the bus 405 for storing static information and instructions for the processor 410. A storage device 425, such as a solid state device, magnetic disk or optical disk, can be coupled to the bus 405 to persistently store information and instructions.

The computing system 400 may be coupled via the bus 405 to a display 435, such as a liquid crystal display, or active matrix display, for displaying information to a user such as an administrator of the data processing system or the utility grid. An input device 430, such as a keyboard or voice interface may be coupled to the bus 405 for communicating information and commands to the processor 410. The input device 430 can include a touch screen display 435. The input device 430 can also include a cursor control, such as a mouse, a trackball, or cursor direction keys, for communicating direction information and command selections to the processor 410 and for controlling cursor movement on the display 435. The display 435 can be part of the data processing system 150, or other components of FIG. 1 or FIG. 2.

The processes, systems, and methods described herein can be implemented by the computing system 400 in response to the processor 410 executing an arrangement of instructions contained in main memory 415. Such instructions can be read into main memory 415 from another computer-readable medium, such as the storage device 425. Execution of the arrangement of instructions contained in main memory 415 causes the computing system 400 to perform the illustrative processes described herein. One or more processors in a multi-processing arrangement may also be employed to execute the instructions contained in main memory 415. Hard-wired circuitry can be used in place of or in combination with software instructions together with the systems and methods described herein. Systems and methods described herein are not limited to any specific combination of hardware circuitry and software.

Although an example computing system has been described in FIG. 4, the subject matter including the operations described in this specification can be implemented in other types of digital electronic circuitry, or in computer software, firmware, or hardware, including the structures disclosed in this specification and their structural equivalents, or in combinations of one or more of them.

### FURTHER EXAMPLES

The following examples pertain to further embodiments, from which numerous permutations and configurations will be evident.

Example 1 includes a system. The system can refer to or include a data processing system having one or more processors coupled with memory. The data processing system can be located at a site. The data processing system can obtain a waveform data set comprising characteristics of power consumption measured for the site during a first time interval at a first sampling rate; determine power-system values based on the waveform data set; determine harmonic information based on a frequency transform performed on the waveform data set; construct, based on the power-system values and the harmonic information, a processed waveform data set having a time series of values at a second sampling rate, wherein the second sampling rate is less than the first sampling rate; predict, based on the processed waveform data set, using one or more models, a characteristic of load at the site during a second time interval; and execute an action related to power delivery for the site based on the characteristic of the load predicted during the second time interval.

Example 2 includes the subject matter of Example 1, wherein the characteristics of power consumption comprise voltage waveforms and current waveforms.

Example 3 includes the subject matter of any of Examples 1 and 2, wherein the first sampling rate is at least 7 kHz.

Example 4 includes the subject matter of any of Examples 1 through 3, wherein the first sampling rate is at least 32 kHz.

Example 5 includes the subject matter of any of Examples 1 through 4, wherein the harmonic information comprises magnitude and phase information.

Example 6 includes the subject matter of any of Examples 1 through 5, wherein the power-system values comprise at least one of reactive power, real power, or apparent power.

Example 7 includes the subject matter of any of Examples 1 through 6, wherein the data processing system is further configured to: generate statistical metrics based on the harmonic information; detect, based on the statistical metrics, anomalies in the waveform data set; remove the anomalies from the waveform data set; and construct the processed waveform data set with the anomalies removed.

Example 8 includes the subject matter of any of Examples 1 through 7, wherein to predict the characteristic of the load at the site during the second time interval, the data processing system is further configured to: detect, using the one or more models, patterns in the processed waveform data set; and input the patterns into the one or more models to predict the characteristic of the load at the site during the second time interval.

Example 9 includes the subject matter of any of Examples 1 through 8, wherein the one or more models comprises a convolution neural network, and the data processing system is further configured to: detect the patterns using the convolution neural network.

Example 10 includes the subject matter of any of Examples 1 through 9, wherein the one or more models comprises a recurrent neural network architecture, and the data processing system is further configured to: input the patterns into the recurrent neural network architecture to predict the characteristic of the load at the site during the second time interval.

Example 11 includes the subject matter of any of Examples 1 through 10, wherein the one or more models comprises a linear regression technique, and the data processing system is further configured to: predict, using the linear regression technique, the characteristic of the load at the site during the second time interval.

Example 12 includes the subject matter of any of Examples 1 through 11, wherein the one or more models comprises a decision tree architecture, and the data processing system is further configured to: predict, using the decision tree architecture, the characteristic of the load at the site during the second time interval.

Example 13 includes the subject matter of any of Examples 1 through 12, wherein the data processing system is further configured to: obtain a second waveform data set comprising the characteristics of power consumption measured for the site during the second time interval at the first sampling rate; determine a characteristic of the load based on the second waveform data set; compare the characteristic of the load based on the second waveform data set with the characteristic of the load predicted during the second time interval; and update the one or more models based on the comparison.

Example 14 includes the subject matter of any of Examples 1 through 13, wherein the data processing system is further configured to: compare the characteristic of the load predicted during the second time interval with a threshold; and execute, based on the comparison, the action comprising transmitting a notification of the comparison to a server remote from the data processing system.

Example 15 includes a method, comprising: obtaining, by a data processing system, comprising one or more processors coupled with memory, located at a site, a waveform data set comprising characteristics of power consumption measured for the site during a first time interval at a first sampling rate; determining, by the data processing system, power-system values based on the waveform data set; determining, by the data processing system, harmonic information based on a frequency transform performed on the waveform data set; construct, by the data processing system, based on the power-system values and the harmonic information, a processed waveform data set having a time series of values at a second sampling rate, wherein the second sampling rate is less than the first sampling rate; predicting, by the data processing system, based on the processed waveform data set, using one or more models, a characteristic of load at the site during a second time interval; and executing, by the data processing system, an action related to power delivery for the site based on the characteristic of the load predicted during the second time interval.

Example 16 includes the subject matter of Example 15, comprising: generating, by the data processing system, statistical metrics based on the harmonic information; detecting, by the data processing system, based on the statistical metrics, anomalies in the waveform data set; removing, by the data processing system, the anomalies from the waveform data set; and constructing, by the data processing system, the processed waveform data set with the anomalies removed.

Example 17 includes the subject matter of Examples 15 and 16, wherein predicting the characteristic of the load at the site during the second time interval comprises: detecting, by the data processing system, using the one or more models, patterns in the processed waveform data set; and inputting, by the data processing system, the patterns into the one or more models to predict the characteristic of the load at the site during the second time interval.

Example 18 includes the subject matter of Examples 15 through 17, comprising: comparing, by the data processing system, the characteristic of the load predicted during the second time interval with a threshold; and executing, by the data processing system, based on the comparison, the action comprising transmitting a notification to a server remote from the data processing system.

Example 19 includes the subject matter of Examples 15 through 18, wherein: the characteristics of power consumption comprise voltage waveforms and current waveforms; the first sampling rate is at least 32 kHz; and the harmonic information comprises magnitude and phase information.

Example 20 includes a non-transitory computer-readable medium storing processor executable instructions that, when executed by one or more processors, cause the one or more processors to: obtain a waveform data set comprising characteristics of power consumption measured for a site during a first time interval at a first sampling rate; determine power-system values based on the waveform data set; determine harmonic information based on a frequency transform performed on the waveform data set; construct, based on the power-system values and the harmonic information, a processed waveform data set having a time series of values at a second sampling rate, wherein the second sampling rate is less than the first sampling rate; predict, based on the processed waveform data set, using one or more models, a characteristic of load at the site during a second time interval; and execute an action related to power delivery for the site based on the characteristic of the load predicted during the second time interval.

Some of the descriptions herein emphasize the structural independence of the aspects of the system components (e.g., arbitration component) and illustrate one grouping of operations and responsibilities of these system components. Other groupings that execute similar overall operations are understood to be within the scope of the present application. Modules can be implemented in hardware or as computer instructions on a non-transient computer-readable storage medium, and modules can be distributed across various hardware-or computer-based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a Compact Disk Read-Only Memory (CD-ROM), a flash memory card, a Programmable Read-Only Memory (PROM), RAM, a ROM, or a magnetic tape. In general, the computer-readable programs can be implemented in any programming language, such as List Processing (LISP), Practical Extraction and Reporting Language (PERL), C, C++, C#, Programmation en Logique (PROLOG), or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an field programmable gate array (FPGA) or an application specific integrated circuit (ASIC). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA or an ASIC. Devices suitable for storing computer program instructions and data can include non-volatile memory, media and memory devices, including by way of example semiconductor memory devices, e.g., Erasable Programmable Read-Only Memory (EPROM), Electrically Erasable Programmable Read-Only Memory (EEPROM), and flash memory devices; magnetic disks, e.g., internal hard disks or removable disks; magneto optical disks; and CD ROM and Digital Versatile Disk Read-Only Memory (DVD-ROM) disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a LAN and a WAN, an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence has any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

The systems and methods described herein may be embodied in other specific forms without departing from the characteristics thereof. Scope of the systems and methods described herein is thus indicated by the appended claims, rather than the foregoing description, and changes that come within the meaning and range of equivalency of the claims are embraced therein.

While this specification contains many specific implementation details, these should not be construed as limitations on the scope of any inventions or of what can be claimed, but rather as descriptions of features specific to particular embodiments of particular aspects. Certain features described in this specification in the context of separate embodiments can also be implemented in combination in a single embodiment. Conversely, various features described in the context of a single embodiment can also be implemented in multiple embodiments separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the embodiments described above should not be understood as requiring such separation in all embodiments, and it should be understood that the described program components and systems can generally be integrated in a single software product or packaged into multiple software products.

Thus, particular embodiments of the subject matter have been described. In some cases, the actions recited in the claims can be performed in a different order and still achieve desirable results. In addition, the processes depicted in the accompanying figures do not necessarily require the particular order shown, or sequential order, to achieve desirable results.

What is claimed is:

1. A system, comprising:
a data processing system, comprising one or more processors coupled with memory, located at a site, to:
obtain a waveform data set comprising characteristics of power consumption measured for the site during a first time interval at a first sampling rate;
determine power-system values based on the waveform data set;
determine harmonic information based on a frequency transform performed on the waveform data set;
construct, based on the power-system values and the harmonic information, a processed waveform data set having a time series of values at a second sampling rate, wherein the second sampling rate is less than the first sampling rate;
predict, based on the processed waveform data set, using one or more models, a characteristic of load at the site during a second time interval; and
execute an action related to power delivery for the site based on the characteristic of the load predicted during the second time interval.

2. The system of claim 1, wherein the characteristics of power consumption comprise voltage waveforms and current waveforms.

3. The system of claim 1, wherein the first sampling rate is at least 7 kHz.

4. The system of claim 1, wherein the first sampling rate is at least 32 kHz.

5. The system of claim 1, wherein the harmonic information comprises magnitude and phase information.

6. The system of claim 1, wherein the power-system values comprise at least one of reactive power, real power, or apparent power.

7. The system of claim 1, wherein the data processing system is further configured to:
generate statistical metrics based on the harmonic information;
detect, based on the statistical metrics, anomalies in the waveform data set;
remove the anomalies from the waveform data set; and
construct the processed waveform data set with the anomalies removed.

8. The system of claim 1, wherein to predict the characteristic of the load at the site during the second time interval, the data processing system is further configured to:
detect, using the one or more models, patterns in the processed waveform data set; and
input the patterns into the one or more models to predict the characteristic of the load at the site during the second time interval.

9. The system of claim 8, wherein the one or more models comprises a convolution neural network, and the data processing system is further configured to:
detect the patterns using the convolution neural network.

10. The system of claim 8, wherein the one or more models comprises a recurrent neural network architecture, and the data processing system is further configured to:
input the patterns into the recurrent neural network architecture to predict the characteristic of the load at the site during the second time interval.

11. The system of claim 8, wherein the one or more models comprises a linear regression technique, and the data processing system is further configured to:
predict, using the linear regression technique, the characteristic of the load at the site during the second time interval.

12. The system of claim 8, wherein the one or more models comprises a decision tree architecture, and the data processing system is further configured to:
predict, using the decision tree architecture, the characteristic of the load at the site during the second time interval.

13. The system of claim 1, wherein the data processing system is further configured to:
obtain a second waveform data set comprising the characteristics of power consumption measured for the site during the second time interval at the first sampling rate;
determine a characteristic of the load based on the second waveform data set;
compare the characteristic of the load based on the second waveform data set with the characteristic of the load predicted during the second time interval; and
update the one or more models based on the comparison.

14. The system of claim 1, wherein the data processing system is further configured to:
compare the characteristic of the load predicted during the second time interval with a threshold; and
execute, based on the comparison, the action comprising transmitting a notification of the comparison to a server remote from the data processing system.

15. A method, comprising:
obtaining, by a data processing system, comprising one or more processors coupled with memory, located at a site, a waveform data set comprising characteristics of power consumption measured for the site during a first time interval at a first sampling rate;
determining, by the data processing system, power-system values based on the waveform data set;
determining, by the data processing system, harmonic information based on a frequency transform performed on the waveform data set;
construct, by the data processing system, based on the power-system values and the harmonic information, a processed waveform data set having a time series of values at a second sampling rate, wherein the second sampling rate is less than the first sampling rate;
predicting, by the data processing system, based on the processed waveform data set, using one or more models, a characteristic of load at the site during a second time interval; and
executing, by the data processing system, an action related to power delivery for the site based on the characteristic of the load predicted during the second time interval.

16. The method of claim 15, comprising:
generating, by the data processing system, statistical metrics based on the harmonic information;
detecting, by the data processing system, based on the statistical metrics, anomalies in the waveform data set;
removing, by the data processing system, the anomalies from the waveform data set; and
constructing, by the data processing system, the processed waveform data set with the anomalies removed.

17. The system of claim 1, wherein predicting the characteristic of the load at the site during the second time interval comprises:
detecting, by the data processing system, using the one or more models, patterns in the processed waveform data set; and
inputting, by the data processing system, the patterns into the one or more models to predict the characteristic of the load at the site during the second time interval.

18. The method of claim 15, comprising:
comparing, by the data processing system, the characteristic of the load predicted during the second time interval with a threshold; and
executing, by the data processing system, based on the comparison, the action comprising transmitting a notification to a server remote from the data processing system.

19. The method of claim 15, wherein:
the characteristics of power consumption comprise voltage waveforms and current waveforms;
the first sampling rate is at least 32 kHz; and
the harmonic information comprises magnitude and phase information.

20. A non-transitory computer-readable medium storing processor executable instructions that, when executed by one or more processors, cause the one or more processors to:
obtain a waveform data set comprising characteristics of power consumption measured for a site during a first time interval at a first sampling rate;
determine power-system values based on the waveform data set;
determine harmonic information based on a frequency transform performed on the waveform data set;
construct, based on the power-system values and the harmonic information, a processed waveform data set having a time series of values at a second sampling rate, wherein the second sampling rate is less than the first sampling rate;
predict, based on the processed waveform data set, using one or more models, a characteristic of load at the site during a second time interval; and
execute an action related to power delivery for the site based on the characteristic of the load predicted during the second time interval.
